(19) United States
(12) Patent Application Publication
(10) Pub. No.: US 2009/0035603 A1
(43) Pub. Date: Feb. 5, 2009

(54) METHOD FOR PRODUCING RARE EARTH METAL-BASED PERMANENT MAGNET HAVING COPPER PLATING FILM ON SURFACE THEREOF

(75) Inventor: Toshinobu Niinae, Saitama (JP)

Correspondence Address: KRATZ, QUINTOS & HANSON, LLP, 1420 K Street, N.W., Suite 400, WASHINGTON, DC, 20005, US

(73) Assignee: Hitachi Metals, Ltd.,, Tokyo (JP)

(21) Appl. No.: 12/278,443

(22) PCT Filed: Feb. 7, 2007
(86) PCT No.: PCT/JP2007/052131

§ 371 Date: Aug. 6, 2008

(30) Foreign Application Priority Data
Feb. 7, 2006 (JP) 2006-029983

(51) Int. Cl. B32B 15/01; C25D 3/38

(52) U.S. Cl. 428/674; 205/295

(57) ABSTRACT

An objective of the invention is to provide a method for producing a rare earth metal-based permanent magnet having on the surface thereof a copper plating film by using a novel plating solution for use in a copper electroplating treatment capable of forming a copper plating film having excellent adhesiveness on the surface of a rare earth metal-based permanent magnet. As a means for solving the problem, the method for producing a rare earth metal-based permanent magnet having a copper plating film on the surface thereof according to the invention is characterized in that the production method comprises forming a copper plating film on the surface of the rare earth metal-based permanent magnet by applying a copper electroplating treatment using a plating solution whose pH is adjusted to a range from 9.0 to 11.5 and containing at least: (1) Cu²⁺ ions, (2) an organic phosphoric acid having two or more phosphorus atoms and/or a salt thereof, (3) gluconic acid and/or a salt thereof, (4) a sulfate and/or a nitrate, and (5) at least one organic carboxylic acid selected from oxalic acid, tartaric acid, citric acid, malonic acid, and malic acid, and/or a salt thereof; provided that a copper salt is excluded from the components (2) to (5).

### TECHNICAL FIELD

The present invention relates to a method for producing a rare earth metal-based permanent magnet having on the surface thereof a copper plating film having excellent adhesiveness by using a novel plating solution for use in a copper electroplating treatment.

### BACKGROUND ART

Rare earth metal-based permanent magnets, for instance, R—Fe—B based permanent magnets represented by a Nd—Fe—B based permanent magnet, or R—Fe—N based permanent magnets represented by a Sm—Fe—N based permanent magnet, etc., utilize inexpensive materials abundant in resources and possess superior magnetic characteristics; particularly among them, the R—Fe—B based permanent magnets are employed today in various fields. However, since rare earth metal-based permanent magnets contain a highly reactive rare earth metal: R, they are apt to be oxidized and corroded in ambient, and in case they are used without applying any surface treatment, corrosion tends to proceed from the surface in the presence of small acidic or alkaline substance or water to generate rust, and this brings about the degradation and the fluctuation of magnetic characteristics. Moreover, in case such a rusty magnet is embedded in a magnetic circuit and a like device, there is fear of scattering rust as to contaminate peripheral components. In the light of such circumstances, there has been employed a method for forming a copper plating film, which is a film having superior corrosion resistance, on the surface of the rare earth metal-based permanent magnet.

In general, methods for forming copper plating films are roughly classified into a copper electroplating treatment and a copper electrolessplating treatment; however, it is important to control the plating solution in case a copper plating film is formed on the surface of the rare earth metal-based permanent magnet by means of a copper electrolessplating treatment so as to prevent problems from occurring, because rare earth metals and iron, which are the metal constituents of the magnet, elute out into the plating solution and react with the reducing agent in the plating solution, and the formation of copper plating films proceeds on the surface of the rare earth metals and iron eluted out into the plating solution. However, this is not always easy to put into practice. Furthermore, the plating solution for use in a copper electrolessplating treatment is generally expensive. Accordingly, in case of forming a copper plating film on the surface of a rare earth metal-based permanent magnet, in general, a simple and low cost copper electroplating treatment is employed.

In case of forming a copper plating film on the surface of a rare earth metal-based permanent magnet by means of a copper electroplating treatment, an alkaline plating solution is preferred to be used by taking into consideration of the strong corrosive properties under acidic conditions on the rare earth metal-based permanent magnet. Accordingly, in general, a plating solution containing copper cyanide (copper cyanide plating bath) had been used. However, although copper cyanide plating bath has high utility value considering that it provides a copper plating film having excellent properties and is an easily controllable plating solution, its environmental impact is not negligible because it contains highly toxic cyan. Thus, recently, a plating solution containing copper pyrophosphate (copper pyrophosphate plating bath) is being used more frequently in the place of copper cyanide plating bath; however, since copper pyrophosphate plating bath contains large amount of free copper ions, in case an attempt is made to form a copper plating film directly on the surface of the rare earth metal-based permanent magnet by using copper pyrophosphate plating bath, substitution plating reaction occurs between an electrically base metal constituting the surface of the magnet, i.e., iron and the like, and copper which is an electrically noble metal, thereby causing substitution precipitation of copper on the surface of the magnet. Such factors affect the formation of a copper plating film having excellent adhesiveness, which is found problematic.

In the light of such circumstances, the present inventor has proposed in patent literature 1 a method for forming a copper plating film on the surface of a rare earth metal-based permanent magnet, which comprises carrying out a copper electroplating treatment by using a plating solution having its pH adjusted to a range from 11.0 to 13.0 and containing 0.03 mol/L to 0.5 mol/L of copper sulfate, 0.05 mol/L to 0.7 mol/L of ethylenediamine tetraacetic acid, 0.02 mol/L to 1.0 mol/L of sodium sulfate, and 0.1 mol/L to 1.0 mol/L of at least one type selected from tartarates and citrates. According to this method, a copper plating film having extremely superior adhesiveness can be formed on the surface of a rare earth metal-based permanent magnet, as compared with the case of applying a copper electroplating treatment by using copper pyrophosphate plating bath. However, even with this method, it was found still unfeasible to form a copper plating film on the surface of a rare earth metal-based permanent magnet, which assures sufficiently high adhesiveness for the corrosion resistance necessary for a rare earth metal-based permanent magnet used under severe environment.

In such a case, the adhesiveness of a copper plating film can be compensated by a method, as disclosed in patent literature 1, which comprises forming a nickel strike plating film on the surface of the rare earth metal-based permanent magnet, and then, forming a copper plating film (with regard to a method for forming a nickel strike plating film on the surface of a rare earth metal-based permanent magnet, reference can be made to, for instance, patent literature 2). This method enables forming a laminated film having extremely superior adhesiveness on the surface of a rare earth metal-based permanent magnet, however, a nickel plating film is apt to co-precipitate hydrogen during the electroplating process. Hence, in case of forming a nickel strike plating film on the surface of the rare earth metal-based permanent magnet, there is fear of causing embrittlement of the magnet due to the co-precipitated hydrogen, which leads to the degradation of magnetic characteristics of the magnet. Thus, the development of a novel method capable of forming directly a copper plating film having excellent adhesiveness on the surface of a rare earth metal-based permanent magnet by means of a copper electroplating treatment is keenly demanded.

Under such circumstances, in patent literature 3 is proposed “a surface treatment method for magnets, characterized by forming a first protective film comprising a copper film on the surface of a magnet containing rare earth metals, by electroplating with the use of a copper plating solution containing at least a copper salt compound, a phosphorus compound, an aliphatic phosphonic acid compound, and a hydroxide”, as a method for forming a copper plating film having excellent adhesiveness on the surface of a rare earth metal-based permanent magnet by means of a copper electroplating treatment. However, concerning the aliphatic phosphonic acid compound, which is the constituent component of the plating solution, patent literature 3 only mentions a phosphonic acid alkali metal compound, a phosphonic acid transition metal compound, and the like, as examples; which reference can be made to paragraph number 0039 in the description thereof, but since no specific compounds are exemplified, regretfully, the actual process cannot be understood.

### Patent Literature 1: JP-A-2004-137533

### Patent Literature 2: JP-A-6-13218

### Patent Literature 3: JP-A-2001-295091

### DISCLOSURE OF THE INVENTION

### Problems the Invention is to Solve

An objective of the invention is to provide a method for producing a rare earth metal-based permanent magnet having on the surface thereof a copper plating film by using a novel plating solution for use in a copper electroplating treatment capable of forming a copper plating film having excellent adhesiveness on the surface of a rare earth metal-based permanent magnet.

### Means for Solving the Problems

In the light of aforementioned points, on forming a copper plating film on the surface of a rare earth metal-based permanent magnet by means of a copper electroplating treatment, the present inventor has set as the basic principle to use a chelating agent having a high chelate stability constant for Cu2+ ions and a plating solution adjusted to alkaline region, thereby preventing substitution precipitation of copper from occurring on the surface of the magnet due to substitution plating reaction between an electrically base metal constituting the surface of the magnet, i.e., iron and the like, and copper which is an electrically noble metal; thus, an organic phosphoric acid having two or more phosphorus atoms and/or a salt thereof, such as 1-hydroxyethylidene-1,1-diphosphonic acid (which is denoted as “HEDP” hereinafter), aminotrimethylenephosphonic acid (which is denoted as “ATMP” hereinafter), and the like, is used as a chelating agent. Among them, HEDP is a chelating agent long known in the art, and since in JP-A-59-136491 is disclosed a method for carrying out a copper electroplating treatment by using a plating solution containing Cu²⁺ ions and HEDP (although there is not disclosed applying the plating method on a rare earth metal-based permanent magnet), it has been expected that this method is capable of forming a copper plating film having excellent adhesiveness on the surface of a rare earth metal-based permanent magnet. However, unexpectedly, on performing a cross-cut peeling test according to JIS K5400 standard to the copper plating film thus formed, it was found that the film had such a poor adhesiveness that the film easily peeled off from the surface of the magnet.

Accordingly, the present inventor searched why it is not possible to form a copper plating film having excellent adhesiveness on the surface of a rare earth metal-based permanent magnet by the method disclosed in JP-A-59-136491, and then, it has been found that, in case a rare earth metal-based permanent magnet was immersed in a plating solution adjusted to alkaline region to suppress corrosion from occurring to the magnet, surface deterioration of the magnet occurred due to the generation of a passive film made of iron hydroxide and the like originating from the metal constituents of the magnet on the surface of the magnet. As a result, it has been identified that the adhesiveness of the copper plating film with respect to the surface of the magnet decreases because the copper plating film is formed on the deteriorated surface of the magnet. Then, in order to suppress such a passive film from generating on the surface of a rare earth metal-based permanent magnet, gluconic acid and/or a salt thereof was added as a chelating agent having a high chelate stability constant for Fe ions into the plating solution, and in this manner, it has been found that a copper plating film having excellent adhesiveness can be formed on the surface of a rare earth metal-based permanent magnet.

A method for producing a rare earth metal-based permanent magnet having a copper plating film on the surface thereof according to the invention made based on the above findings is, as described in Claim 1, characterized in that the production method comprises forming a copper plating film on the surface of the rare earth metal-based permanent magnet by applying a copper electroplating treatment using a plating solution whose pH is adjusted to a range from 9.0 to 11.5 and containing at least: (1) Cu²⁺ ions, (2) an organic phosphoric acid having two or more phosphorus atoms and/or a salt thereof, (3) gluconic acid and/or a salt thereof, (4) a sulfate and/or anitrate, and (5) at least one organic carboxylic acid selected from oxalic acid, tartaric acid, citric acid, malonic acid, and malic acid, and/or a salt thereof; provided that a copper salt is excluded from the components (2) to (5).

Further, the production method as described in Claim 2 is, in the production method claimed in Claim 1, characterized in that the component (2) is at least one selected from HEDP and/or a salt thereof and ATMP and/or a salt thereof.

Furthermore, the production method as described in Claim 3 is, in the production method claimed in Claim 1, characterized in that the component (3) is sodium gluconate.

Moreover, the production method as described in Claim 4 is, in the production method claimed in Claim 1, characterized in that the component (4) is sodium sulfate.

Further, the production method as described in Claim 5 is, in the production method claimed in Claim 1, characterized in that the component (5) is sodium tartrate.

Furthermore, the production method as described in Claim 6 is, in the production method claimed in Claim 1, characterized in that the pH of the plating solution is adjusted to a range from 9.0 to 11.5, and that it contains at least: (1) 0.02 mol/L to 0.15 mol/L of Cu²⁺ ions, (2) 0.1 mol/L to 0.5 mol/L of an organic phosphoric acid having two or more phosphorus atoms and/or a salt thereof, (3) 0.005 mol/L to 0.5 mol/L of gluconic acid and/or a salt thereof, (4) 0.01 mol/L to 5.0 mol/L of a sulfate and/or a nitrate, and (5) 0.01 mol/L to 0.5 mol/L of at least one organic carboxylic acid selected from oxalic acid, tartaric acid, citric acid, malonic acid, and malic acid, and/or a salt thereof; provided that a copper salt is excluded from the components (2) to (5).

Further, the production method as described in Claim 7 is, in the production method claimed in Claim 1, characterized in that the copper electroplating treatment is effected using a plating solution at a bath temperature in a range from 40° C. to 70° C.

In addition, a rare earth metal-based permanent magnet having a copper plating film on the surface thereof according to the invention is, as described in Claim 8, characterized in that it is produced by the production method described in Claim 1.

Further additionally, a plating solution for use in a copper electroplating treatment according to the invention is, as described in Claim 9, characterized in that its pH is adjusted to a range from 9.0 to 11.5, and that it contains at least: (1) 0.02 mol/L to 0.15 mol/L of Cu²⁺ ions, (2) 0.1 mol/L to 0.5 mol/L of an organic phosphoric acid having two or more phosphorus atoms and/or a salt thereof, (3) 0.005 mol/L to 0.5 mol/L of gluconic acid and/or a salt thereof, (4) 0.01 mol/L to 5.0 mol/L of a sulfate and/or a nitrate, and (5) 0.01 mol/L to 0.5 mol/L of at least one organic carboxylic acid selected from oxalic acid, tartaric acid, citric acid, malonic acid, and malic acid, and/or a salt thereof; provided that a copper salt is excluded from the components (2) to (5).

### EFFECT OF THE INVENTION

According to the invention, there is provided a method for producing a rare earth metal-based permanent magnet having on the surface thereof a copper plating film by using a novel plating solution for use in a copper electroplating treatment capable of forming a copper plating film having excellent adhesiveness on the surface of a rare earth metal-based permanent magnet.

### BRIEF DESCRIPTION OF THE DRAWINGS

FIG. 1

It is a SEM photograph showing the surface of a copper plating film formed on the surface of a magnet according to an embodiment described in Example 1.

FIG. 2

It is a SEM photograph showing the surface of a copper plating film formed on the surface of a magnet according to an embodiment described in Comparative Example 3.

FIG. 3

It is a graph showing the effect of the sodium sulfate on increasing the critical current density of a plating solution according to an embodiment described in Test Example 1.

### BEST MODE FOR CARRYING OUT THE INVENTION

The method for producing a rare earth metal-based permanent magnet having on the surface thereof a copper plating film according to the invention is characterized in that the production method comprises forming a copper plating film on the surface of the rare earth metal-based permanent magnet by applying a copper electroplating treatment using a plating solution whose pH is adjusted to a range from 9.0 to 11.5 and containing at least: (1) Cu²⁺ ions, (2) an organic phosphoric acid having two or more phosphorus atoms and/or a salt thereof, (3) gluconic acid and/or a salt thereof, (4) a sulfate and/or anitrate, and (5) at least one organic carboxylic acid selected from oxalic acid, tartaric acid, citric acid, malonic acid, and malic acid, and/or a salt thereof; provided that a copper salt is excluded from the components (2) to (5).

In the invention, the source for supplying Cu²⁺ ions which constitute the plating solution for use in a copper electroplating treatment is not particularly limited, and there can be used, for instance, copper sulfate, cupric chloride, copper pyrophosphate, cupric hydroxide, copper nitrate, copper carbonate, and the like.

An organic phosphoric acid having two or more phosphorus atoms and/or a salt thereof is used as a chelating agent having a high chelate stability constant for Cu²⁺ ions. As the organic phosphoric acid having two or more phosphorus atoms, there can be mentioned HEDP, ATMP, and the like mentioned above; as a salt thereof, examples include a sodium salt, a potassium salt, and the like.

Gluconic acid and/or a salt thereof is used as a chelating agent having a high chelate stability constant for Fe ions. As gluconate, there can be mentioned a sodium salt, a potassium salt, and the like.

A sulfate and/or a nitrate is used for increasing the critical current density of the plating solution, to thereby extend the range of the electric current capable of forming a favorable copper plating film on the surface of the magnet. Preferably, there can be mentioned sodium sulfate. By using sodium sulfate, not only the plating efficiency can be improved to increase productivity, but also the density of the copper plating film formed on the surface of the magnet can be improved.

At least one organic carboxylic acid selected from oxalic acid, tartaric acid, citric acid, malonic acid, and malic acid, and/or a salt thereof is used for improving the density and the smoothness of the copper plating film formed on the surface of the magnet, and for accelerating copper elution by suppressing anodic passivation from occurring. As a salt of such organic carboxylic acid, there can be mentioned a sodium salt, a potassium salt, and the like; but preferred among them is sodium tartrate.

The reason why the pH of the plating solution for use in a copper electroplating treatment is set in a range from 9.0 to 11.5 is because, if the pH value should be lower than 9.0, the chelating power of the chelating agent blended in the plating solution for forming complexes with copper ions decreases as to increase free copper ions in the plating solution, and this may likely cause substitution precipitation of copper on the surface of the magnet; on the other hand, if the pH value exceeds 11.5, anodic passivation tends to occur on carrying out a copper electroplating treatment, and this may likely cause difficulties in controlling the plating bath or unfavorably influence on the film quality of the copper plating film that is formed on the surface of the magnet due to the generation of hydroxyl complexes of copper and the like in the plating solution. As a preferred combination of the component (2) and the component (3), which function as chelating agents, there can be mentioned a combination of HEDP and sodium gluconate. In case this combination is adopted, a copper plating film having a very dense film quality and composed of fine electrodeposited particles can be formed with excellent adhesiveness on the surface of a magnet.

As a preferred plating solution for use in a copper electroplating treatment, there can be mentioned a plating solution having its pH adjusted to a range from 9.0 to 11.5, and containing at least: (1) 0.02 mol/L to 0.15 mol/L of Cu²⁺ ions, (2) 0.1 mol/L to 0.5 mol/L of an organic phosphoric acid having two or more phosphorus atoms and/or a salt thereof, (3) 0.005 mol/L to 0.5 mol/L of gluconic acid and/or a salt thereof, (4) 0.01 mol/L to 5.0 mol/L of a sulfate and/or a nitrate, and (5) 0.01 mol/L to 0.5 mol/L of at least one organic carboxylic acid selected from oxalic acid, tartaric acid, citric acid, malonic acid, and malic acid, and/or a salt thereof; provided that a copper salt is excluded from the components (2) to (5). The content of Cu²⁺ ions is set in a range from 0.02 mol/L to 0.15 mol/L. This is because if the content should be lower than 0.02 mol/L, there is fear of considerably lowering the critical current density; on the other hand, if the content exceeds 0.15 mol/L, there is fear of increasing free copper ions in the plating solution, which may cause substitution precipitation of copper on the surface of the magnet. The content of an organic phosphoric acid having two or more phosphorus atoms and/or a salt thereof is set in a range from 0.1 mol/L to 0.5 mol/L. This is because if the content should be lower than 0.1 mol/L, it is likely that the copper ions are not sufficiently chelated in the plating solution; on the other hand, the content exceeding 0.5 mol/L only brings about an increase in cost, but no effect is expected. The content of gluconic acid and/or a salt thereof is set in a range from 0.005 mol/L to 0.5 mol/L. This is because if the content should be lower than 0.005 mol/L, there is fear of causing difficulties in suppressing surface deterioration of the magnet which is due to the generation of a passive film made of iron hydroxide and the like originating from the metal constituents of the magnet on the surface of the magnet, or of making it impossible to achieve a sufficiently high current efficiency; on the other hand, if the content exceeds 0.5 mol/L, it is likely that vigorous elution of the metal constituents of the magnet, such as iron and the like, occurs from the surface of the magnet, thereby making a copper plating film unfeasible. The content of a sulfate and/or a nitrate is set in a range from 0.01 mol/L to 5.0 mol/L. This is because if the content should be lower than 0.01 mol/L, there is fear of impairing the precipitation efficiency of copper due to the decrease in the electric conductivity of the plating solution; on the other hand, the content exceeding 5.0 mol/L only brings about an increase in cost, but no effect is expected. In addition, it is preferred to set an upper limit of 0.5 mol/L for the content of a sulfate and/or a nitrate. This is because it the content of the sulfate and/or the nitrate exceeds 0.5 mol/L, there is little increment in effect. However, in a practical process of mass production using a large barrel or on treating a large amount of compact magnets at a time, and in case the magnets are packed at high density inside the barrel, uneven plating may generate due to the lowering of the current density at the central portion of the barrel. Such inconveniences can be avoided, however, by adding a sulfate and/or a nitrate in excess to the plating solution. The content of at least one organic carboxylic acid selected from oxalic acid, tartaric acid, citric acid, malonic acid, and malic acid, and/or a salt thereof is set in a range from 0.01 mol/L to 0.5 mol/L. This is because if the content should be lower than 0.01 mol/L, it is likely that the effect of improving the density or the smoothness of the plating film, or the effect of accelerating copper elution by suppressing anodic passivation from occurring is insufficiently exhibited; on the other hand, if the content exceeds 0.5 mol/L, there is fear of impairing the precipitation efficiency of copper due to the decrease in the current efficiency of the cathode. The pH can be adjusted by using, if necessary, sodium hydroxide and the like.

Furthermore, the plating solution for use in a copper electroplating treatment may contain known components such as aminoalcohols, sulfites, and the like as a depolarizer for an anode, a conductive agent, and the like.

The copper electroplating treatment may be carried out, basically, in accordance with the commonly employed copper electroplating treatment conditions, but preferred is to set a plating bath temperature of the plating solution in a range from 40° C. to 70° C. If the temperature should be lower than 40° C., there is fear of considerably lowering the critical current; on the other hand, if the temperature exceeds 70° C., disproportionation reaction likely occurs between the anode and free copper, causing difficulties in controlling the plating bath. Plating may be conducted by any manner, such as rack plating, barrel plating, and the like. The cathode current density is preferably set in a range from 0.05 A/dm² to 4.0 A/dm². If the current density should be lower than 0.05 A/dm², the film formation efficiency becomes inferior, and there may be cases in which the plating deposition potential cannot be achieved, thereby resulting in no generation of films. On the other hand, if the current density exceeds 4.0 A/dm², it is likely that vigorous hydrogen generation occurs, and pits or discoloration generate on the surface of the formed copper plating film.

According to the invention, a copper plating film having excellent adhesiveness can be formed on the surface of a rare earth metal-based permanent magnet; the coating film has such a high peeling strength that no peeling off occurs, for example, on performing a cross-cut peeling test according to JIS K5400 standard. Furthermore, the copper plating film according to the invention that is formed on the surface of a rare earth metal-based permanent magnet has superior luster, and is extremely dense and smooth. Preferably, the thickness of the copper plating film formed on the surface of a rare earth metal-based permanent magnet is in a range from 0.5 μm to 30 μm. If the thickness should be less than 0.5 μm, there is fear that a sufficiently high corrosion resistance cannot be imparted to a magnet; on the other hand, if the thickness exceeds 30 μm, there is fear of making it difficult to acquire an effective volume as a magnet, or of lowering the production efficiency. A corrosion resistant film as exemplified by a metal plating film may be laminated on the surface of the copper plating film formed on the surface of the rare earth metal-based permanent magnet.

### EXAMPLES

The invention is explained in further detail below by means of examples and comparative examples, but it should be understood that the invention is not limited thereto. In the examples and comparative examples below, first, magnetic bodies were prepared by blending the starting raw materials, i.e., electrolytic iron, ferroboron, and Nd as R, at the predetermined magnet composition, and after melting and casting, the resulting product was coarsely crushed and finely ground by a mechanical crushing method to obtain a fine powder having a granularity in a range from 3 μm to 10 μm. Then, the fine powder thus obtained was shaped under a magnetic field of 10 kOe, sintered under argon atmosphere at 1100° C. for 1 hour, and the resulting sinter was subjected to aging treatment at 600° C. for 2 hours to obtain a magnetic body having a composition of 15Nd-7B-78Fe (at %). Three test pieces were cut out from this magnetic body, namely, a test piece 3 mm×20 mm×40 mm in size (which is denoted as “test piece A” hereinafter), a test piece 1 mm×1.5 mm×2 mm in size (which is denoted as “test piece B” hereinafter), and a test piece 4 mm×2.9 mm×2.9 mm in size (which is denoted as “test piece C” hereinafter), which were each subjected to surface activation by using a 0.1 mol/L of nitric acid solution and rinsing.

### Example 1

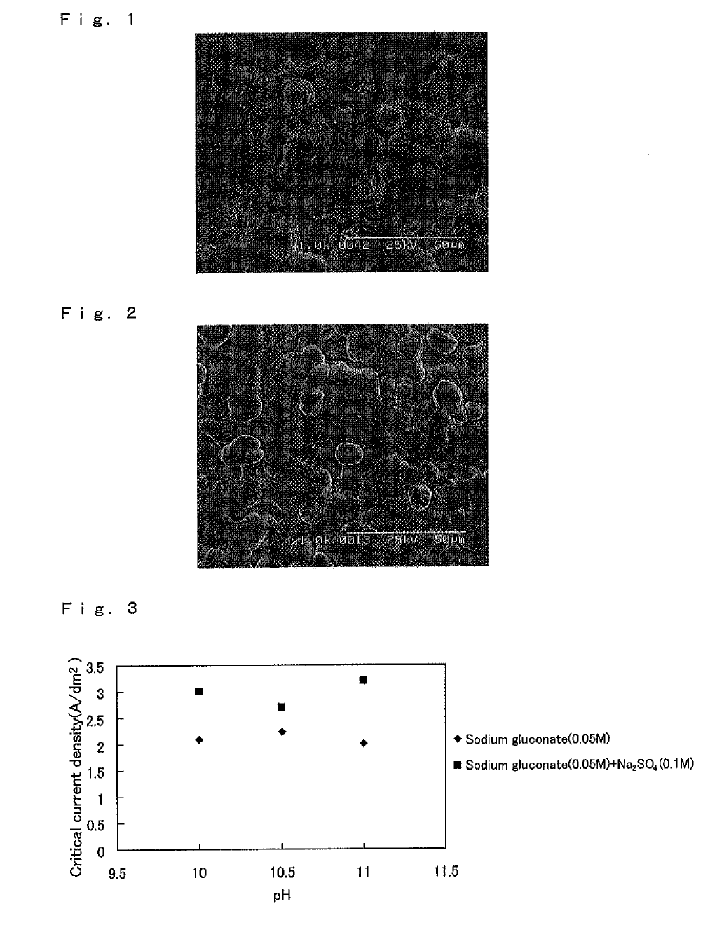

Test piece A was subjected to a barrel type copper electroplating treatment by using a plating solution for use in a copper electroplating treatment containing: (1) 0.06 mol/L of copper sulfate pentahydrate, (2) 0.15 mol/L of HEDP, (3) 0.01 mol/L of sodium gluconate, (4) 0.1 mol/L of sodium sulfate, and (5) 0.1 mol/L of sodium tartrate, and whose pH was adjusted to 11.0 by using sodium hydroxide, and the plating bath temperature of the plating solution controlled to 60° C., while applying a cathode current density of 0.3 A/dm² for 40 minutes. Thus was formed a copper plating film on the surface of test piece A. The thickness of the copper plating film formed on the surface of test piece A was 4.0 μm (an average value of n=10). The copper plating film was found to have excellent adhesiveness free from peeling off even on performing a cross-cut peeling test according to JIS K5400 standard (evaluated at n=10). Furthermore, the copper plating film exhibited superior luster, and was very dense and smooth (confirmed by surface SEM observation: reference can be made on FIG. 1).

### Comparative Example 1

Test pieces A and B were subjected to a barrel type copper electroplating treatment by using a plating solution for use in a copper electroplating treatment containing: (1) 0.16 mol/L of copper sulfate pentahydrate, (2) 0.07 mol/L of phosphonobutane tricarboxylic acid (a chelating agent having a chelate stability constant lower than 10.0 for Cu²⁺ ions under pH of 9.0 to 11.5), and (3) 0.1 mol/L of sodium dihydrogenphosphate dihydrate, and whose pH was adjusted to 10.0 by using sodium hydroxide, and the plating bath temperature of the plating solution controlled to 60° C., while applying a cathode current density of 1.0 A/dm² for 30 minutes. However, copper hydroxide precipitates generated in the plating solution, and no copper plating film was formed on the surfaces of test pieces A and B.

### Comparative Example 2

Test pieces A and B were subjected to a barrel type copper electroplating treatment by using a plating solution for use in a copper electroplating treatment containing: (1) 0.30 mol/L of copper sulfate pentahydrate, (2) 0.07 mol/L of phosphonobutane tricarboxylic acid, and (3) 0.05 mol/L of potassium pyrophosphate, and whose pH was adjusted to 10.0 by using sodium hydroxide, and the plating bath temperature of the plating solution controlled to 60° C., while applying a cathode current density of 1.0 A/dm² for 30 minutes. However, copper hydroxide precipitates generated in the plating solution, and no copper plating film was formed on the surfaces of test pieces A and B.

### Comparative Example 3

A copper electroplating treatment was applied to the surface of test piece A under the same conditions as in Example 1 and by using the same plating solution for use in a copper electroplating treatment as in Example 1, except for excluding sodium tartrate, to thereby form a copper plating film on the surface of test piece A. However, the copper plating film formed on the surface of test piece A was found to be inferior in the density and the smoothness (confirmed by surface SEM observation: reference can be made on FIG. 2). Accordingly, in view of Example 1 and Comparative Example 3, the effect of sodium tartrate on improving the density and the smoothness of the copper plating film formed on the surface of the magnet was confirmed.

### Example 2

A copper electroplating treatment was applied to the surface of test piece A under the same conditions as in Example 1 and by using the same plating solution for use in a copper electroplating treatment as in Example 1, except for using sodium oxalate in the place of sodium tartrate, to thereby form a copper plating film on the surface of test piece A. The copper plating film formed on the surface of test piece A exhibited superior luster, and was very dense and smooth (confirmed by surface SEM observation).

### Example 3

A copper electroplating treatment was applied to the surface of test piece A under the same conditions as in Example 1 and by using the same plating solution for use in a copper electroplating treatment as in Example 1, except for using sodium citrate in the place of sodium tartrate, to thereby form a copper plating film on the surface of test piece A. The copper plating film formed on the surface of test piece A exhibited superior luster, and was very dense and smooth (confirmed by surface SEM observation).

### Example 4

A copper electroplating treatment was applied to the surface of test piece A under the same conditions as in Example 1 and by using the same plating solution for use in a copper electroplating treatment as in Example 1, except for using sodium malonate in the place of sodium tartrate, to thereby form a copper plating film on the surface of test piece A. The copper plating film formed on the surface of test piece A exhibited superior luster, and was very dense and smooth (confirmed by surface SEM observation).

### Example 5

A copper electroplating treatment was applied to the surface of test piece A under the same conditions as in Example 1 and by using the same plating solution for use in a copper electroplating treatment as in Example 1, except for using sodium malate in the place of sodium tartrate, to thereby form a copper plating film on the surface of test piece A. The copper plating film formed on the surface of test piece A exhibited superior luster, and was very dense and smooth (confirmed by surface SEM observation).

### Example 6

A copper plating film was formed on the surfaces of test pieces A and C by applying a copper electroplating treatment under the same conditions as in Example 1 and by using the same plating solution for use in a copper electroplating treatment as in Example 1. The thickness of the copper plating film formed on the surfaces of test pieces A and C was 4.6 Mm (an average value of n=5). The copper plating film exhibited superior luster, and was very dense and smooth (confirmed by surface SEM observation). Then, test pieces A and C each having the copper plating film on the surface thereof were subjected to a barrel type nickel electroplating treatment by using a known Watt nickel plating solution while controlling the plating bath temperature of the plating solution to 50° C., and applying a cathode current density of 0.3 A/dm² for 30 minutes. Thus was formed a nickel plating film on the surface of the copper plating film. The thickness of the nickel plating film formed on the surface of the copper plating film was 4.0 μm (an average value of n=5). The resulting test pieces A and C each having on the surface thereof a laminated film comprising the nickel plating film and the copper plating film were heated at 450° C. for 10 minutes. As a result, on the laminated film, no phenomena such as blistering, cracking, peeling, and the like were observed, thereby showing excellent adhesiveness of the laminated film with respect to the surfaces of test pieces A and C (evaluated at n=3). Furthermore, on performing a cross-cut peeling test according to JIS K5400 standard to test piece A having on the surface thereof a laminated film comprising the nickel plating film and the copper plating film, no peeling off of the laminated film occurred (evaluated at n=2). Further, the magnetic characteristics of test piece C having on the surface thereof a laminated film comprising the nickel plating film and the copper plating film were evaluated to obtain a Br of 1.36 T (1.38 T for the original test piece C), an H_{cj} of 1191.6 kA/m (1181.8 kA/m, ditto), an Hₖ of 1168.2 kA/m (1154.6 kA/m, ditto), and a squareness ratio (Hₖ/HCl) of 0.980 (0.977, ditto) (an average value of n=5), thus showing the excellent magnetic characteristics well comparable to those of the original test piece C.

### Example 7

A laminated film comprising a nickel plating film and a copper plating film was formed on the surfaces of test pieces A and C by first applying a copper electroplating treatment under the same conditions as in Example 6 and by using a plating solution for use in a copper electroplating treatment containing: (1) 0.08 mol/L of copper sulfate pentahydrate, (2) 0.15 mol/L of HEDP, (3) 0.05 mol/L of sodium gluconate, (4) 2.0 mol/L of sodium sulfate, and (5) 0.1 mol/L of sodium tartrate, and whose pH was adjusted to 11.0 by using sodium hydroxide; and by then applying a nickel electroplating treatment under the same conditions as in Example 6. The properties of the copper plating film formed on the surfaces of the test pieces, adhesiveness of the laminated film with respect to the surfaces of the test pieces, and the magnetic characteristics of the test pieces having on the surface thereof the laminated film were evaluated by the same method as in Example 6 to obtain evaluation results well comparable to those obtained in Example 6.

### Test Example 1

The critical current density was measured on the plating solution for use in a copper electroplating treatment containing: (1) 0.06 mol/L of copper sulfate pentahydrate, (2) 0.15 mol/L of HEDP, (3) 0.05 mol/L of sodium gluconate, (4) 0.1 mol/L of sodium sulfate, and (5) 0.1 mol/L of sodium tartrate, and whose pH was adjusted to 10.0, 10.5, and 11.0 by using sodium hydroxide.

Furthermore, the same plating solution for use in a copper electroplating treatment as above, except for excluding sodium sulfate, was subjected to the measurement of the critical current density.

The results are given in FIG. 3. From FIG. 3, the effect of sodium sulfate on increasing the critical current density of the plating solution was confirmed.

### INDUSTRIAL APPLICABILITY

The invention has industrial applicability in the point that it provides a method for producing a rare earth metal-based permanent magnet having on the surface thereof a copper plating film by using a novel plating solution for use in a copper electroplating treatment capable of forming a copper plating film having excellent adhesiveness on the surface of a rare earth metal-based permanent magnet.

1. A method for producing a rare earth metal-based permanent magnet having a copper plating film on the surface thereof, characterized in that the production method comprises forming a copper plating film on the surface of the rare earth metal-based permanent magnet by applying a copper electroplating treatment using a plating solution whose pH is adjusted to a range from 9.0 to 11.5 and containing at least: (1) Cu²⁺ ions, (2) an organic phosphoric acid having two or more phosphorus atoms and/or a salt thereof, (3) gluconic acid and/or a salt thereof, (4) a sulfate and/or a nitrate, and (5) at least one organic carboxylic acid selected from oxalic acid, tartaric acid, citric acid, malonic acid, and malic acid, and/or a salt thereof; provided that a copper salt is excluded from the components (2) to (5).

2. The production method as claimed in claim 1, characterized in that the component (2) is at least one selected from 1-hydroxyethylidene-1,1-diphosphonic acid and/or a salt thereof and aminotrimethylenephosphonic acid and/or a salt thereof.

3. The production method as claimed in claim 1, characterized in that the component (3) is sodium gluconate.

4. The production method as claimed in claim 1, characterized in that the component (4) is sodium sulfate.

5. The production method as claimed in claim 1, characterized in that the component (5) is sodium tartrate.

6. The production method as claimed in claim 1, characterized in that the pH of the plating solution is adjusted to a range from 9.0 to 11.5, and that it contains at least: (1) 0.02 mol/L to 0.15 mol/L of Cu²⁺ ions, (2) 0.1 mol/L to 0.5 mol/L of an organic phosphoric acid having two or more phosphorus atoms and/or a salt thereof, (3) 0.005 mol/L to 0.5 mol/L of gluconic acid and/or a salt thereof, (4) 0.01 mol/L to 5.0 mol/L of a sulfate and/or a nitrate, and (5) 0.01 mol/L to 0.5 mol/L of at least one organic carboxylic acid selected from oxalic acid, tartaric acid, citric acid, malonic acid, and malic acid, and/or a salt thereof; provided that a copper salt is excluded from the components (2) to (5).

7. The production method as claimed in claim 1, characterized in that the copper electroplating treatment is effected using a plating solution at a bath temperature in a range from 40° C. to 70° C.

8. A rare earth metal-based permanent magnet having a copper plating film on the surface thereof, characterized in that it is produced by the production method as claimed in claim 1.

9. A plating solution for use in a copper electroplating treatment, characterized in that its pH is adjusted to a range from 9.0 to 11.5, and that it contains at least: (1) 0.02 mol/L to 0.15 mol/L of Cu²⁺ ions, (2) 0.1 mol/L to 0.5 mol/L of an organic phosphoric acid having two or more phosphorus atoms and/or a salt thereof, (3) 0.005 mol/L to 0.5 mol/L of gluconic acid and/or a salt thereof, (4) 0.01 mol/L to 5.0 mol/L of a sulfate and/or a nitrate, and (5) 0.01 mol/L to 0.5 mol/L of at least one organic carboxylic acid selected from oxalic acid, tartaric acid, citric acid, malonic acid, and malic acid, and/or a salt thereof; provided that a copper salt is excluded from the components (2) to (5).
